(19) United States
(12) Patent Application Publication
(10) Pub. No.: US 2026/0340117 A1
(43) Pub. Date: Oct. 29, 2026

(54) SNAPSHOT INTERVALS FOR PRESERVING DATA DURING RANSOMWARE EVENTS

(71) Applicant: International Business Machines Corporation, Armonk, NY (US)

(72) Inventors: Yves Alexandre Beraldo dos Santos, Marana, AZ (US); Christopher J. Vollmar, Mississauga (CA); Dionysios Diamantopoulos, Zurich (CH)

(21) Appl. No.: 19/192,140

(22) Filed: Apr. 28, 2025

(51) Int. Cl. G06F 21/55; G06F 11/1446

(52) U.S. Cl. CPC G06F 21/554; G06F 11/1469; G06F 2201/84; G06F 2221/034

(57) ABSTRACT

A method, according to one embodiment, comprises detecting a first ransomware event in a storage system, and calculating a first interval for performing snapshots of data volumes of the storage system, where the first interval is calculated based on available storage space in the storage system and a speed of encryption being performed on the data volumes by a malicious user device during the first ransomware event. The method further comprises causing first snapshots of the data volumes to be performed according to the first interval, and using the first snapshots to recover from the first ransomware event. A computer program product, according to another embodiment, comprises one or more computer-readable storage media, program instructions stored on the one or more storage media to perform the foregoing method.

### BACKGROUND

The present invention relates to cybersecurity, and more specifically, this invention relates to ransomware attacks.

Cybersecurity involves the protection of computer systems and networks from attacks by malicious actors. Depending on the type(s) of computer systems and/or networks that are affected, a cybersecurity attack may result in unauthorized information disclosure, damage to hardware and/or software, corruption of data, etc.

While some platforms have been developed to protect computer systems and networks from such attacks, threats are consistently evolving. Computer systems and networks thereby face various types of attacks over time. Ransomware is one such type of cybersecurity attack that has been difficult for conventional products to detect and overcome.

### SUMMARY

A method, according to one embodiment, comprises detecting a first ransomware event in a storage system, and calculating a first interval for performing snapshots of data volumes of the storage system, where the first interval is calculated based on available storage space in the storage system and a speed of encryption being performed on the data volumes by a malicious user device during the first ransomware event. The method further comprises causing first snapshots of the data volumes to be performed according to the first interval, and using the first snapshots to recover from the first ransomware event.

A computer program product, according to another embodiment, comprises one or more computer-readable storage media, program instructions stored on the one or more storage media to perform the foregoing method.

A computer system, according to another embodiment, comprises a processor set, one or more computer-readable storage media, and program instructions stored on the one or more storage media to cause the processor set to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a diagram of a tiered data storage system, in accordance with one embodiment of the present invention.

FIG. 3A is a flowchart of a method, in accordance with one embodiment of the present invention.

FIG. 3B is a flowchart of sub-operations of an operation of the flowchart of FIG. 3A, in accordance with one embodiment of the present invention.

FIGS. 4A-4E are snapshots of virtual storage of a storage system, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for performing a burst of snapshots for preserving data during ransomware events.

In one general embodiment, a method comprises detecting a first ransomware event in a storage system, and calculating a first interval for performing snapshots of data volumes of the storage system, where the first interval is calculated based on available storage space in the storage system and a speed of encryption being performed on the data volumes by a malicious user device during the first ransomware event. The method further comprises causing first snapshots of the data volumes to be performed according to the first interval, and using the first snapshots to recover from the first ransomware event.

In another general embodiment, a computer program product comprises one or more computer-readable storage media, program instructions stored on the one or more storage media to perform the foregoing method.

In another general embodiment, a computer system comprises a processor set, one or more computer-readable storage media, and program instructions stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as snapshot interval determination code of block 150 for preserving data during ransomware events. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

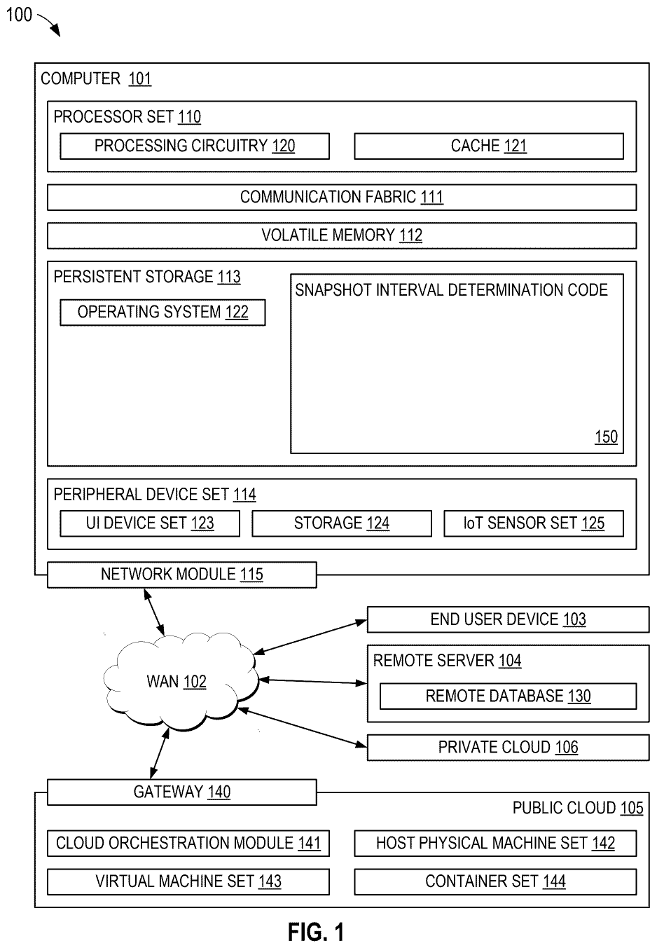

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

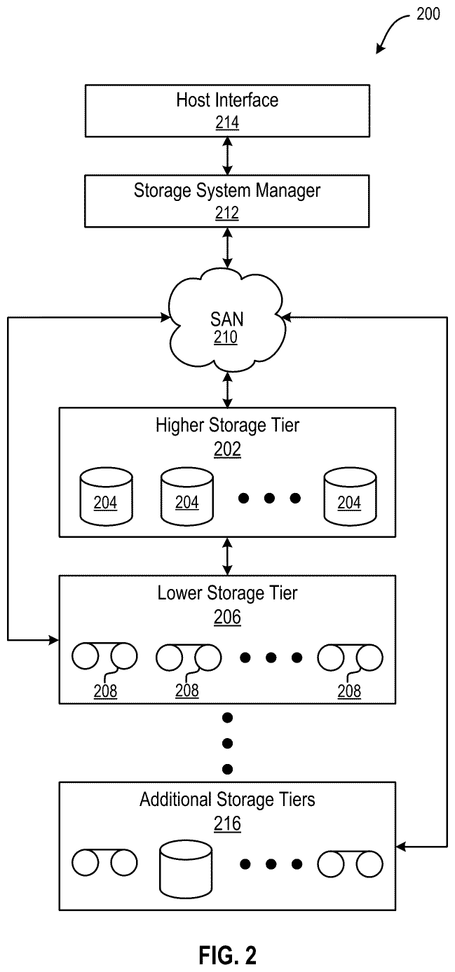

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a SAN, as shown in FIG. 2, Internet Protocol (IP) network, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As mentioned elsewhere above, cybersecurity involves the protection of computer systems and networks from attacks by malicious actors. Depending on the type(s) of computer systems and/or networks that are affected, a cybersecurity attack may result in unauthorized information disclosure, damage to hardware and/or software, corruption of data, etc.

While some platforms have been developed to protect computer systems and networks from such attacks, threats are consistently evolving. Computer systems and networks thereby face various types of attacks over time. Ransomware is one such type of cybersecurity attack that has been difficult for conventional products to detect and overcome.

During a ransomware corruption event, once an alert has been raised, conventional measures for dealing with the ransomware event include negotiating with a malicious actor that initiated the ransomware attack. However, this process is unreliable because the malicious actor often insists on large monetary sums. Based on this, remaining solutions may rely on rolling back data in a data storage system to a version that existed before the ransomware corruption event. However, this rolling back results in a loss of all data modifications made to the data in the data storage system between that version of the data storage system throughout the ransomware corruption event.

Within the context of virtual machines, during a ransomware corruption event, data stored within a data storage system is typically overwritten by a malicious actor device that gains access to the data. More specifically, over time during this access, the malicious actor device often encrypts the data throughout a writing process, e.g., also referred to herein as a “cascaded corruption”. Only the malicious actor device has an encryption key used to encrypt the data, and therefore, the data is rendered into an unusable state. One issue that results from a cascaded corruption of virtual machines is that the virtual machines all share the same underlying volume. Based on this, healthy machines are only able to be recovered based on the time of the last good copy of the corrupted machines. This means that data and/or transactions are lost from the last working copy of the volume. It should be noted that although ransomware events described above detail a malicious actor encrypting data via a writing process, in some approaches, the techniques described herein may additionally and/or alternatively be applied to other types of ransomware. For example, these other types of ransomware may include a malicious actor deleting the data (wiperware), scrambling the data with a particular pattern, and/or otherwise corrupting the data in general.

Use of snapshots or backups for cybersecurity threat protection rely on a regular schedule of performing snapshots for the housed workloads in the storage system. This ensures that the amount of storage space that the cybersecurity threat protection consumes remains predictable (so as to not run out of storage space). These snapshots however do not consider that when a cyber threat is detected, corruption of the data may happen over time. The fixed schedule of these periodic backups create a vulnerability within a storage system in that a cybersecurity threat may compromise a significant portion of data of the storage system until between a subsequent backup being triggered.

In order to mitigate the vulnerabilities described above, the embodiments and approaches described herein include techniques for performing a burst of ad hoc successive snapshots during a ransomware event that creates a series of recovery points for a volume. More specifically, within these techniques, in response to a determination that a ransomware attack has been initiated, a frequency of performing snapshots is calculated and initiated to capture many snapshots with small changes (to thereby provide relatively more potential recovery points). These techniques thereby minimize data loss of workloads supported by that volume. The burst copies are policy triggered and retained for a configurable time period bound by available capacity to track and hold changes. This way, storage constraints of the storage system are not exceeded during operation of the storage system and while mitigating cybersecurity events. Note that this configurable time period may be set using one or more techniques that would become apparent to one of ordinary skill in the art after reading the descriptions herein. In some approaches, these techniques include auditing and/or reading a preset policy that defines (and may be dynamically updated by an administrator device) how long to retain snapshots and/or copy intervals. In some other approaches, these techniques may use an artificial intelligence (AI) model to calculate a maximum number of resources that can be devoted to retain snapshots and/or perform snapshots, e.g., such as based on the AI models evaluation of historical data sets. In yet another approach, the rules and/or policies used to determine the configurable time period may additionally and/or alternatively be adjusted based on event type, e.g., based on type of ransomware detected, based on an amount of processing resources available, etc.

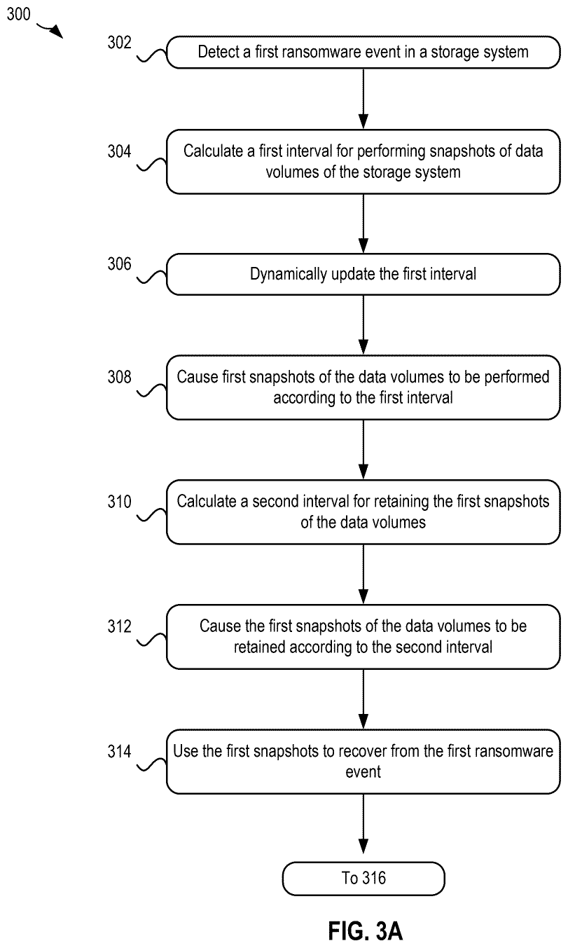

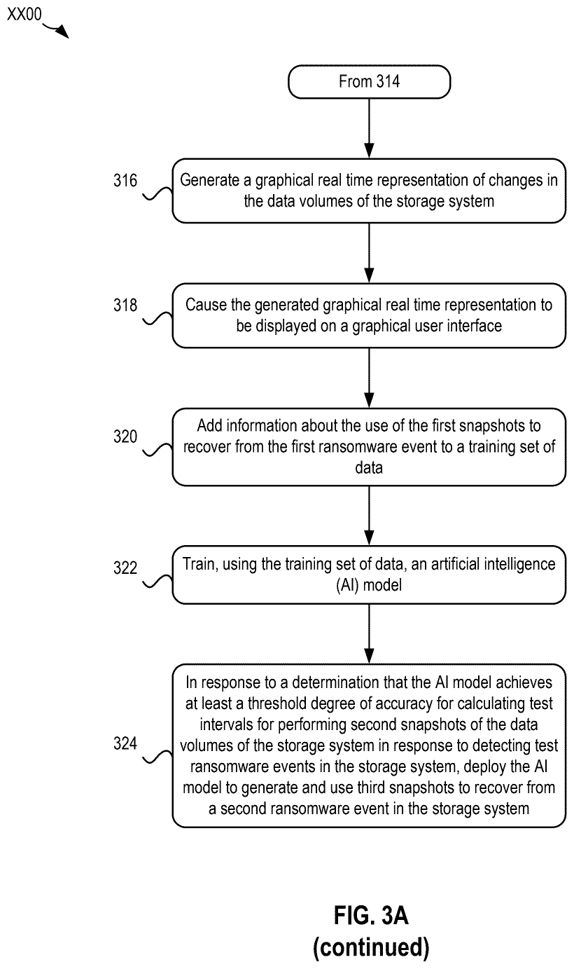

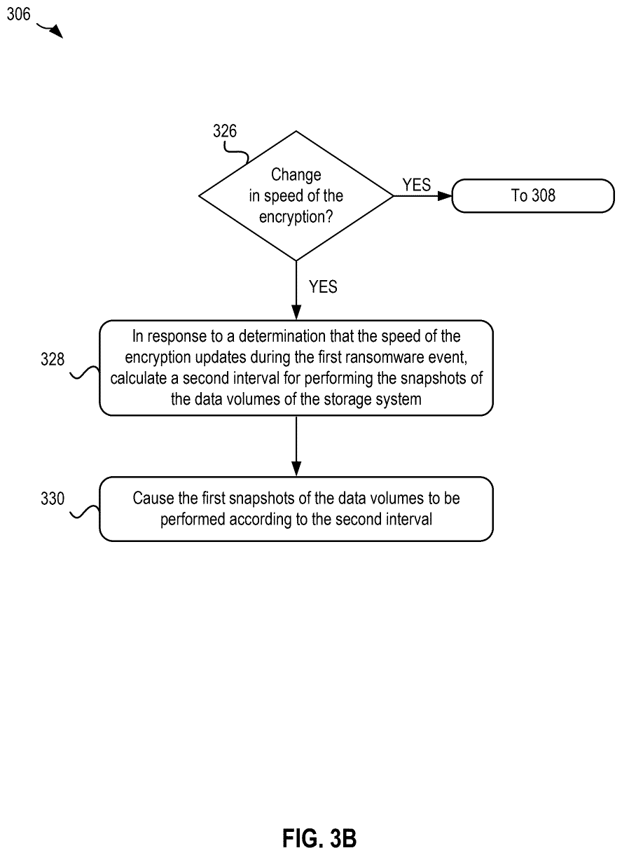

Now referring to FIG. 3A, a flowchart of a method 300 is shown according to one embodiment. The method 300 may be performed in accordance with aspects of the present invention in any of the environments depicted in FIGS. 1-4E, among others, in various embodiments. Of course, more or fewer operations than those specifically described in FIG. 3A may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

The storage system described herein, in some approaches, includes physical and/or logical resources. For example, in some approaches, the storage system includes storage resources, and storage space of these resources may store data volumes. In some other approaches, the storage system additionally and/or alternatively includes virtual storage that may be based on resources separated throughout a computing environment and/or across one or more storage tiers, e.g., see FIGS. 1-2.

With continued reference to FIG. 3A, method 300, in some approaches, includes monitoring for a cybersecurity event. In some preferred approaches, the cybersecurity event includes a ransomware event that occurs within the storage system (within the data thereof), e.g., a ransomware attack attempted and/or initiated on data of volumes of the storage system. Monitoring techniques performed to detect potential cybersecurity event(s) may be of a type that would become apparent to one of ordinary skill in the art after reading the descriptions herein. In some approaches, these monitoring techniques include monitoring for encryption of at least some of the data of the data volumes of the storage system. In some other approaches, these monitoring techniques include these monitoring techniques additionally and/or alternatively include report of an unauthorized access to the data volumes and/or user access credentials being obtained by an unauthorized user device.

Operation 302 includes detecting a first ransomware event in the storage system. In some approaches, the first ransomware event includes data of the data volumes of the storage system being encrypted. In such approaches, the detecting the first ransomware event in the storage system may comprise detecting an unscheduled encryption of at least some of the data of the data volumes of the storage system. This encryption may be detected by bits of the data being converted to different characters, bits of the data being replaced with a pattern of repeating characters, the data being deleted, etc. Because the data volumes may be associated with virtual storage that comprises more than one physical storage devices at more than one physical storage site, in some approaches, the monitoring may be performed on one more than one physical storage device. In some other approaches, the monitoring is performed on a single physical storage device that the data volumes are located on.

In response to determining the first ransomware event, a first interval for performing snapshots of data volumes of the storage system is calculated, e.g., see operation 304. Note that the snapshots of the data volutes may or may not be immutable based on system capability and/or settings, depending on the approach. It should further be noted that the first interval for performing snapshots of data volumes of the storage system is different than an interval that snapshots may otherwise be performed in the storage system, e.g., otherwise during normal function of the storage system while a ransomware event is not detected within the storage system. Instead, this calculated interval, in some approaches, amounts to a triggered burst of snapshots of virtual machines of the storage system. For context, a burst of snapshots may be defined as a series of incremental snapshots that are performed at the first interval (or another determined interval) that is greater than a typical number of snapshots performed during normal operation within the storage system. More specifically, this “normal operation” may be defined as operation during which a cybersecurity event, e.g., a malicious attack event, is determined to not be occurring and/or is not actually occurring. In some approaches, the burst of snapshots may be defined as being at least a predetermined multiple of an average number of snapshots performed during historical operation of the storage system (within a predetermined period of past time). In other words, the determined intervals described herein, in some approaches, are at least the predetermined multiple of the average number of snapshots performed during historical operation of the storage system. Preferred factors for calculating the first interval (and/or other calculated intervals described herein) are described below.

In some preferred approaches, the first interval is calculated based on available storage space in the storage system. For example, in some approaches, the first interval is calculated by identifying a predetermined portion of the available storage space in the storage system is identified and divided by an amount of time that the first ransomware event is estimated to last (which may be estimated by a forecasting model trained to analyze and make estimations based on historical sets of data). For context, the predetermined portion of the available storage space may, in some approaches, be an amount of storage space that is equal to a difference of the total available storage space and an amount of storage space needed to complete queued data operations (so as to mitigate latency of data operations after the first ransomware event is mitigated). In another approach, the predetermined portion of the available storage space may include all available storage within the storage system. In yet another approach, the predetermined portion of the available storage space may be dedicated storage space for storing the snapshots during ransomware events.

The first interval is preferably additionally and/or alternatively calculated based on a speed of encryption being performed on the data volumes by a malicious user device during the first ransomware event. This speed may be determined by observing percentages of change in the volume based on the encryption being performed. Furthermore, in some approaches, this speed is additionally and/or alternatively be estimated by causing a trained forecasting model to relate the first ransomware event with a previous ransomware event (relate by identifying that the previous ransomware event has at least a predetermined degree of similarity with the first ransomware event), and identifying the speed of the previous ransomware event. Note that, the previous ransomware event may, in some approaches, be a previous ransomware event that was used for training the forecasting model (based on historical data associated with an environment that the first ransomware event occurs in). In some other approaches, the previous ransomware event may be not one specific to the environment that the first ransomware event occurs in, but rather a part of a general training data set. In some approaches, in order to calculate the first interval based on the speed of encryption being performed, the speed of the previous ransomware event may be used to determine a remaining time that the first ransomware event will occur. The determined remaining time may, in some approaches, determine a maximum number of snapshots that may be performed (thereby equally distributed over the remaining time to establish the interval to perform the snapshots) without exceeding available storage space in the storage system. In some other approaches, in order to calculate the first interval based on the speed of encryption being performed, a byte rate of writing by the malicious actor is determined and the first interval is set such that a snapshot is performed for each byte of writing performed. In some other approaches, the first interval is calculated based on the speed of encryption being performed such that a snapshot is performed for each predetermined data size being written, e.g., for each chunk of data, for each cluster of data, for each portion of data associated with a different index entry, etc. In yet some other approaches, the first interval may additionally and/or alternatively be determined by other factors such as total potential number of copies that can be managed and/or based on business rules such as acceptable data loss.

It should be noted that this speed of encryption may change at any time. Accordingly, in some approaches, the first interval may be ongoingly calculated and/or modified in response to a determination that one or more of the metrics used to calculate the first interval have changed. For example, operation 306 includes dynamically updating the first interval. Looking to FIG. 3B, exemplary sub-operations of the dynamic updating are illustrated in accordance with one embodiment, one or more of which may be used to perform operation 306 of FIG. 3A. However, it should be noted that the sub-operations of FIG. 3B are illustrated in accordance with one embodiment which is in no way intended to limit the invention.

In some approaches, the dynamic updating consists of determining whether the speed of the encryption updates (changes more than a predetermined threshold amount) during the first ransomware event, e.g., see sub-operation 326. In response to a determination that the speed of the encryption updates (changes more than the predetermined threshold amount) during the first ransomware event (e.g., see “YES” logical path of sub-operation 326), a second interval for performing the snapshots of the data volumes of the storage system is calculated, e.g., see sub-operation 328. Similar techniques described elsewhere herein for calculating the first interval may be used for calculating the second interval. For example, the second interval is, in some approaches, calculated based on the available storage space in the storage system and/or the updated speed of the encryption.

In response to a determination that the speed of the encryption does not update, the method optionally continues to operation 308 (e.g., see “NO” logical path of sub-operation 326).

Sub-operation 330 includes causing (instructing initiation of) the first snapshots of the data volumes to be performed according to the second interval.

Referring again to FIG. 3A, operation 308 includes causing (instructing initiation of) first snapshots of the data volumes to be performed according to the first interval. In some approaches, controller(s) that are configured to cause snapshots on the data volumes are instructed to perform the snapshots according to the first interval. As the snapshots are caused to be performed according to the first interval, a rapid succession of incremental snapshot copies (burst) is established and temporally records a progression of the encryption performed by the malicious user device during the first ransomware event. It should be noted that a length of this recording may depend on the embodiment. In some embodiments, this progression is recording using volume information that includes compressibility, entropy and other system metrics against the data as it is written or not written.

Method 300, in some approaches, comprises calculating a second interval for retaining the first snapshots of the data volumes. Note that the second interval does not necessarily refer to a second time that an interval for retaining the first snapshots of the data volumes is calculated. Instead, in some approaches, the term second interval of the current approach is used in order for one of ordinary skill in the art reading the descriptions herein to be able to distinguish from the first interval calculated in operation 304.

The first snapshots of the data volumes are preferably retained in order to thereafter be used for mitigating and/or recovering from the first ransomware event (which is described elsewhere herein, e.g., see operation 314). However, in order to preserve storage resources within the storage system, a limit that defines how long to retain the first snapshots of the data volumes may be considered and determined via calculation. For example, the second interval is, in some approaches, calculated based on the available storage space in the storage system and the speed of the encryption being performed on the data volumes by the malicious user device during the first ransomware event. In some approaches, the second interval is an amount of time that the first ransomware event is predicted, based on the speed of the encryption, to last plus an amount of time that analyzing the snapshots is estimated to take. In some other approaches, the second interval is additionally and/or alternatively an amount of time that the first ransomware event is predicted, deletion is observed, corruption is observed, etc., similar to as below. The first snapshots of the data volumes are caused to be retained according to the second interval, e.g., see operation 312.

As mentioned elsewhere herein, in some approaches, the speed of the encryption being performed on the data volumes by the malicious user device during the first ransomware event may change, and as a result, the calculated interval(s) may be inaccurate. For example, based on the speed of the encryption decreasing after determination of the interval(s), in some cases, storage usage in the storage system may become likely to and/or actually exceed a storage potential (total available storage resources) of the storage system. Accordingly, in order to prevent the storage potential of the storage system from being exceeded, a threshold of storage usage may be set and enforced. For example, the threshold of storage usage may, in some approaches, be a majority portion of the storage system. In some other approaches, the threshold of storage usage may, in some approaches, be one half of the storage potential of the storage system. In yet another approach, the threshold of storage usage may, in some approaches, be the estimated storage usage amount if the speed of the encryption were to not decrease after determination of the interval(s). In response to a determination that the performance of the first snapshots of the data volumes according to the first interval results in a threshold of storage usage in the storage system being exceeded, a second interval for performing the snapshots of the data volumes of the storage system is calculated. To decrease a rate of usage of the storage potential of the storage system, in some approaches, the second interval for performing the snapshots of the data volumes of the storage system is less than the first interval for performing the snapshots of the data volumes of the storage system. The second interval for performing the snapshots, in some approaches, is calculated using techniques similar to those used for calculating the first interval for performing the snapshots, however the calculations are modified to incorporate the changed speed of the encryption. Furthermore, in some approaches, the second interval for performing the snapshots of the data volumes of the storage system is based on an estimated remaining time that the encryption will last and/or an amount of data that remains unencrypted.

It should be noted that, as described elsewhere herein, encryption being performed on data of the data volumes is one of multiple potential types of ransomware events that techniques described herein may be applied to mitigate. In other words, for other types of ransomware events, the calculated interval(s) may be inaccurate, e.g., based on changing speed of encryption, based on changing speed of deletion, based on changing speed of data corruption rate, etc. For a storage array snapshot, in some approaches, the rate of change of data in general is the most important factor in determining the capacity needed to store the snapshot. This is because the storage stores both the previous version of the data, and the modifications to that data, in order to maintain both snapshots of the data consistent.

Subsequent to the calculation of the second interval for performing the snapshots of the data volumes of the storage system being performed, a remainder of the first snapshots of the data volumes are caused to be performed according to the second interval. In some approaches, the interval is a rate at which the snapshots are performed, and therefore the first snapshots of the data volumes are caused to be performed according to the second interval until a determination is made that the first ransomware event has ended, e.g., the encryption is determined to stop and/or be stopped.

In some approaches, overwriting of at least some predetermined types of data may be performed during performance of the snapshots of the data volumes of the storage system according to the second interval. In other words, in response to a determination that the use of the first interval resulted in relatively too many snapshots being performed (relatively too many based on the threshold of storage usage in the storage system being exceeded), overwriting of at least some types of data may be performed in order to free storage space for the snapshots of the data volumes of the storage system according to the second interval. For example, in some approaches, at least some of the first snapshots of the data volumes performed according to the first interval are overwritten with new snapshots performed at the second interval. In another example, the other predetermined types of data may additionally and/or alternatively include redundant copies of data stored in the storage system. These redundant copies may be first verified to not be needed for recovering from the first ransomware event, and in some approaches, may be rewritten (to reestablish the redundant copies) after recovering from the first ransomware event.

Operation 314 includes using the first snapshots to recover from the first ransomware event. Recovery from the ransomware event may be accomplished by using the first snapshots with a recovery technique of a type that would become apparent to one of ordinary skill in the art after reading the descriptions herein. In some approaches, these recovery techniques include identifying, within the first snapshots, original data before the data is encrypted, and replacing the encrypted data with the original data. In some other approaches, the recovery techniques additionally and/or alternatively include building a report that characterizes a behavior of the first ransomware event (based on a progression of the first ransomware event throughout the first snapshots). This way, the report may be used to prevent future ransomware attacks and furthermore be used to, during future ransomware attacks, accurately calculate intervals for performing and retaining snapshots.

In some approaches, method 300 further and/or alternatively comprises generating a graphical real time representation of changes in at least some of the data volumes of the storage system, e.g., see operation 316. For context, in some preferred approaches, the changes are based on a difference of existing copies in an immutable snapshot of the volumes and block level changes in the first snapshots. For context, the immutable snapshot may be defined as read only backup point-in-time copies of the data volumes, which may be performed outside of the occurrence of a ransomware event. One example of such immutable snapshots includes Safeguarded Copy (SGC) by INTERNATIONAL BUSINESS MACHINES CORPORATION (IBM). This way, the immutable snapshots are compared against the rapid succession of incremental snapshot copies in order to generate a summary for quick visual interpretation. In some other embodiments, normal snapshots may additionally and/or alternatively be used in response to a determination that immutable copies are not available and/or are not preferred for a variety of business or technical reasons.

The generated graphical real time representation is caused to be displayed on a graphical user interface, e.g., see operation 318. It should be noted that currently, there is a lacking ability to take successive copies of a storage system and volume supporting workloads that are being corrupted in a way that enables creation of multiple recovery point objective (RPO) points for all of the housed workloads in a volume where a status of these RPO points are displayed in the graphical real time representation of changes. Accordingly, the techniques described herein proceed contrary to conventional wisdom and enable solutions to issues, such as ransomware attacks, that compromise security and computing efficiency within a storage system.

As mentioned elsewhere above, the snapshots performed according to the intervals calculated herein are distinguishable from any periodic snapshots of the data volumes that may otherwise be performed during normal function of the storage system (while a ransomware event is not detected within the storage system). In other words, the periodic snapshots of the data volumes are not based on the metrics used to calculate the first and second internals. These periodic snapshots of the data volumes are, in some approaches, postponed during the causing (instructed initiation of) the first snapshots of the data volumes to be performed according to the first interval. This postponement is supplemented with the snapshots performed according to the intervals that are specifically designed (via calculation) to establish detail of the first ransomware event to a degree that allows recovery from the first ransomware event. In response to a determination that the first snapshots are successfully used to recover from the first ransomware event, the periodic snapshots of the data volumes, in some approaches, are caused to resume.

In some approaches, the operations of method 300 may be performed by an AI model that is trained using a predetermined training set of data. For example, in some approaches, various of the operations noted above may be deployed in a trained state of a trained AI model. In order to enable such training, in some approaches, method 300 includes adding information about the use of the first snapshots to recover from the first ransomware event to a training set of data, e.g., see operation 320. This information, in some approaches, includes at least some of the snapshots of data volumes of the storage system performed according to the calculated interval(s). In some other approaches, the information additionally and/or alternatively includes metrics used to calculate the interval(s), e.g., preferably the speed of the encryption. In some other approaches, the information additionally and/or alternatively includes timestamp information, recovery operations performed to recovery from the first ransomware event, etc. Method 300, in some approaches, includes training, using the training set of data, an AI model. The training set of data used to train the AI model may additionally and/or alternatively include information detailing historical cybersecurity attacks on the storage system or other storage systems. This provides additional context to the AI model during training in order for the Ai model to learn how to detect ransomware events in the data contained by a storage system, determine the intervals described herein, and use the snapshots performed according to the intervals to recover from the ransomware event.

Initial training of the AI model may include reward feedback that may, in some approaches, be implemented using a subject matter expert (SME) that generally understands whether the AI model correctly identifies a simulated ransomware event on a training volume of data. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. For example, in response to a determination that the AI model achieves at least a threshold degree of accuracy for calculating test intervals for performing second snapshots of the data volumes of the storage system in response to detecting test ransomware events in the storage system, the AI model is deployed to generate and use third snapshots to recover from a second ransomware event in the storage system and/or another storage system, e.g., see operation 324.

In some further approaches, the AI model may be a neuromyotonic AI model that may improve performance of computer devices in an infrastructure associated with the storage system, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from user devices that access the data of the data volumes after recovering from a ransomware event. Such an AI model ensures that data operations and more specifically, states of data that are compromised by a ransomware event are preserved, where the scale of such analysis and determinations would not otherwise be feasible for a human to perform. This is because humans are not able to efficiently visually monitor data volumes for encryption nor respond to a ransomware event to preserve the data, and would otherwise incorporate processing delays and errors in the data in the process of attempting to do so. Accordingly, management of operations described herein is not able to be achieved by human manual actions.

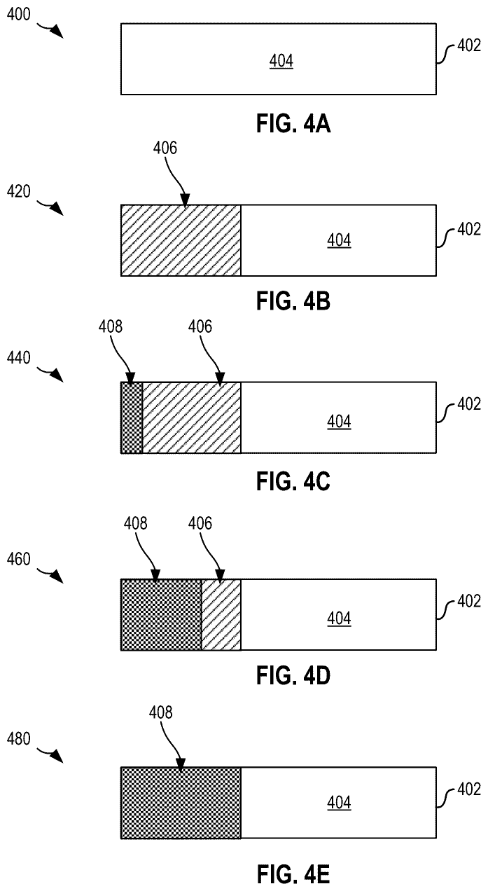

FIGS. 4A, 4B, 4C, 4D and 4E respectively depict snapshots 400, 420, 440, 460, and 480 of virtual storage of a storage system, in accordance with several embodiments. As an option, the present snapshots 400, 420, 440, 460, and 480 may be implemented in conjunction with features from any other embodiment listed herein, such as those described with reference to the other FIGS. Of course, however, such snapshots 400, 420, 440, 460, and 480 and others presented herein may be used in various applications and/or in permutations which may or may not be specifically described in the illustrative embodiments listed herein. Further, the snapshots 400, 420, 440, 460, and 480 presented herein may be used in any desired environment.

Referring first to FIG. 4A, snapshot 400 depicts virtual storage 402 of a storage system. The virtual storage 402 has an available storage resources 404 that is progressively filled by data 406 in data storage operations, e.g., see consumption of available storage resources 404 by data 406 in FIG. 4B.

With reference to FIG. 4C, a portion of the data is encrypted by a ransomware attack, e.g., see encrypted data 408. Comparing FIGS. 4C-4E and assuming that FIGS. 4A-4E run along an advancing time dimension, it may be observed in the snapshots 440, 460, and 480 that over time, the ransomware attack causes more and more of the data to be encrypted, e.g., see all of the data encrypted by the snapshot 480. An issue that would be present by merely taking periodic snapshots of the volumes of the virtual storage 402 of the storage system, and that is mitigated by the techniques described herein, is based on the fact that the ransomware attack may begin after a last periodic snapshot is taken and encrypt the data before a next periodic snapshot is taken. This would cause data operations performed after the last periodic snapshot is taken to be lost. This loss amounts to wasted processing resources, which require additional processing within the storage system to recover from. However, using the techniques described herein, upon detecting the ransomware event, snapshots that preserve these data operations (and more specifically the data 406) are performed and retained according to calculated intervals. In other words, a non-typical burst of snapshots are performed in response to detecting the ransomware event.

The snapshots described above are used for preserving the data and mitigating future ransomware events. For example, the snapshots may be analyzed to identify data to replace the encrypted data with. Furthermore, the snapshots may be used to accurately study characteristics of a behavior of the ransomware event in order to more accurately identify future ransomware events. Yet furthermore, the snapshots may be added to a training set of data to train an AI model to preserve data by performing the operations and techniques described herein.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting a first ransomware event in a storage system;
calculating a first interval for performing snapshots of data volumes of the storage system, wherein the first interval is calculated based on available storage space in the storage system and a speed of encryption being performed on the data volumes by a malicious user device during the first ransomware event;
causing first snapshots of the data volumes to be performed according to the first interval; and
using the first snapshots to recover from the first ransomware event.

2. The method of claim 1, further comprising:
calculating a second interval for retaining the first snapshots of the data volumes,
wherein the second interval is calculated based on the available storage space in the storage system and the speed of the encryption being performed on the data volumes by the malicious user device during the first ransomware event; and
causing the first snapshots of the data volumes to be retained according to the second interval.

3. The method of claim 1, further comprising:
generating a graphical real time representation of changes in the data volumes of the storage system, wherein the changes are based on a difference of existing copies in an immutable snapshot of the volumes and block level changes in the first snapshots; and
causing the generated graphical real time representation to be displayed on a graphical user interface.

4. The method of claim 1, further comprising:
dynamically updating the first interval, wherein the dynamic updating consists of:
in response to a determination that the speed of the encryption updates during the first ransomware event, calculating a second interval for performing the snapshots of the data volumes of the storage system, wherein the second interval is calculated based on the available storage space in the storage system and the updated speed of the encryption, and
causing the first snapshots of the data volumes to be performed according to the second interval.

5. The method of claim 1, wherein the first ransomware event includes data of the data volumes of the storage system being encrypted, wherein the detecting the first ransomware event in the storage system comprises: detecting an unscheduled encryption of at least some of the data of the data volumes of the storage system.

6. The method of claim 1,
wherein periodic snapshots of the data volumes are postponed during the causing the first snapshots of the data volumes to be performed according to the first interval, and further comprising:
in response to a determination that the first snapshots are successfully used to recover from the first ransomware event, resuming the periodic snapshots of the data volumes.

7. The method of claim 1, further comprising:
in response to a determination that the performance of the first snapshots of the data volumes according to the first interval results in a threshold of storage usage in the storage system being exceeded, calculating a second interval for performing the snapshots of the data volumes of the storage system; and
causing the first snapshots of the data volumes to be performed according to the second interval,
wherein at least some of the first snapshots of the data volumes performed according to the first interval are overwritten with new snapshots performed at the second interval.

8. The method of claim 1, further comprising:
adding information about the use of the first snapshots to recover from the first ransomware event to a training set of data;
training, using the training set of data, an artificial intelligence (AI) model; and
in response to a determination that the AI model achieves at least a threshold degree of accuracy for calculating test intervals for performing second snapshots of the data volumes of the storage system in response to detecting test ransomware events in the storage system, deploying the AI model to generate and use third snapshots to recover from a second ransomware event in the storage system.

9. A computer program product comprising:
one or more computer-readable storage media; and
program instructions stored on the one or more storage media to perform operations comprising:
detecting a first ransomware event in a storage system;
calculating a first interval for performing snapshots of data volumes of the storage system, wherein the first interval is calculated based on available storage space in the storage system and a speed of encryption being performed on the data volumes by a malicious user device during the first ransomware event;
causing first snapshots of the data volumes to be performed according to the first interval; and
using the first snapshots to recover from the first ransomware event.

10. The computer program product of claim 9, wherein the operations further comprise:
calculating a second interval for retaining the first snapshots of the data volumes,
wherein the second interval is calculated based on the available storage space in the storage system and the speed of the encryption being performed on the data volumes by the malicious user device during the first ransomware event; and
causing the first snapshots of the data volumes to be retained according to the second interval.

11. The computer program product of claim 9, wherein the operations further comprise:
generating a graphical real time representation of changes in the data volumes of the storage system, wherein the changes are based on a difference of existing copies in an immutable snapshot of the volumes and block level changes in the first snapshots; and
causing the generated graphical real time representation to be displayed on a graphical user interface.

12. The computer program product of claim 9, wherein the operations further comprise:
dynamically updating the first interval, wherein the dynamic updating consists of:
in response to a determination that the speed of the encryption updates during the first ransomware event, calculating a second interval for performing the snapshots of the data volumes of the storage system, wherein the second interval is calculated based on the available storage space in the storage system and the updated speed of the encryption, and
causing the first snapshots of the data volumes to be performed according to the second interval.

13. The computer program product of claim 9, wherein the first ransomware event includes data of the data volumes of the storage system being encrypted, wherein the detecting the first ransomware event in the storage system comprises: detecting an unscheduled encryption of at least some of the data of the data volumes of the storage system.

14. The computer program product of claim 9,
wherein periodic snapshots of the data volumes are postponed during the causing the first snapshots of the data volumes to be performed according to the first interval, and wherein the operations further comprise:
in response to a determination that the first snapshots are successfully used to recover from the first ransomware event, resuming the periodic snapshots of the data volumes.

15. The computer program product of claim 9, wherein the operations further comprise:
in response to a determination that the performance of the first snapshots of the data volumes according to the first interval results in a threshold of storage usage in the storage system being exceeded, calculating a second interval for performing the snapshots of the data volumes of the storage system; and
causing the first snapshots of the data volumes to be performed according to the second interval,
wherein at least some of the first snapshots of the data volumes performed according to the first interval are overwritten with new snapshots performed at the second interval.

16. The computer program product of claim 9, wherein the operations further comprise:
adding information about the use of the first snapshots to recover from the first ransomware event to a training set of data;
training, using the training set of data, an artificial intelligence (AI) model; and
in response to a determination that the AI model achieves at least a threshold degree of accuracy for calculating test intervals for performing second snapshots of the data volumes of the storage system in response to detecting test ransomware events in the storage system, deploying the AI model to generate and use third snapshots to recover from a second ransomware event in the storage system.

17. A computer system comprising:
a processor set;
one or more computer-readable storage media; and
program instructions stored on the one or more storage media to cause the processor set to perform operations comprising:
detecting a first ransomware event in a storage system;
calculating a first interval for performing snapshots of data volumes of the storage system, wherein the first interval is calculated based on available storage space in the storage system and a speed of encryption being performed on the data volumes by a malicious user device during the first ransomware event;
causing first snapshots of the data volumes to be performed according to the first interval; and
using the first snapshots to recover from the first ransomware event.

18. The computer system of claim 17, wherein the operations further comprise:
calculating a second interval for retaining the first snapshots of the data volumes,
wherein the second interval is calculated based on the available storage space in the storage system and the speed of the encryption being performed on the data volumes by the malicious user device during the first ransomware event; and
causing the first snapshots of the data volumes to be retained according to the second interval.

19. The computer system of claim 17, wherein the operations further comprise:
generating a graphical real time representation of changes in the data volumes of the storage system, wherein the changes are based on a difference of existing copies in an immutable snapshot of the volumes and block level changes in the first snapshots; and
causing the generated graphical real time representation to be displayed on a graphical user interface.

20. The computer system of claim 17, wherein the operations further comprise:
dynamically updating the first interval, wherein the dynamic updating consists of:
in response to a determination that the speed of the encryption updates during the first ransomware event, calculating a second interval for performing the snapshots of the data volumes of the storage system, wherein the second interval is calculated based on the available storage space in the storage system and the updated speed of the encryption, and
causing the first snapshots of the data volumes to be performed according to the second interval.
